(19) United States
(12) Patent Application Publication
(10) Pub. No.: US 2007/0102029 A1
(43) Pub. Date: May 10, 2007

(54) Acoustic seal for use in kitchen appliance

(76) Inventor: Allen L. Panther, Cumberland, IN (US)

Correspondence Address: OWENS CORNING, 2790 COLUMBUS ROAD, GRANVILLE, OH, 43023, US

(21) Appl. No.: 11/267,706

(22) Filed: Nov. 4, 2005

(51) Int. Cl. B08B 3/00; B08B 3/12

(52) U.S. Cl. 134/56 D; 134/111; 134/109; 134/198; 134/184

(57) ABSTRACT

An acoustic blanket is provided for an appliance. The acoustic blanket includes a main body, a margin and a fold line connecting the main body to the margin. The margin is folded about the fold line relative to the main body in order to provide an edge seal around the edge of the appliance.

### TECHNICAL FIELD AND INDUSTRIAL APPLICABILITY OF THE INVENTION

The present invention relates generally to kitchen appliance technology and, more particularly, to an acoustic blanket and related method for insulating an under-counter kitchen appliance.

### BACKGROUND OF THE INVENTION

Automatic dishwashers have long been known as a particularly convenient and efficient way to clean dishes following their use. Such dishwashers generally include a washing chamber for holding the dishes and one or more streams of pressurized fluid for washing food and drink residue from the dishes. Unfortunately, the washing process generates considerable noise, which can be quite annoying to the user. In an effort to reduce this noise it has long been known to provide dishwashers with acoustical insulation.

Conventional acoustical insulation systems for dishwashers generally comprise sound transmission barriers and sound absorption layers. Typically, acoustical insulation involves enclosing the noise source in an insulation structure. A typical form of acoustical insulation is a layer of mineral fiber insulation, such as fiberglass insulation, wrapped around or positioned around the source of the unwanted noise. For example, a fiberglass blanket is usually wrapped around the sides, top and rear while separate fiberglass absorbers are usually incorporated into the front door and side panels of an under the counter dishwasher. Together the blanket and absorbers function to reduce the transmission of unwanted sound from the source of the sound in the dishwasher to the kitchen environment.

More recently, manufacturers have begun installing rubber or foam seals around the front edges of under the counter dishwashers to further reduce the sound level produced by such appliances. While effective, such an approach increases the number of parts currently used to block sound transmission and increases the labor required to install these parts. As a consequence, such an approach adds significantly to the cost of manufacturing the appliance.

The present invention relates to a new approach which eliminates the need for a separate rubber or foam seal and reduces the labor necessary to provide insulation to the front edge of an under the counter dishwasher while advantageously reducing sound transmission.

### SUMMARY OF THE INVENTION

To achieve the foregoing and other objects and in accordance with the purposes of the present invention as described herein, an improved acoustic blanket is provided for an appliance. The acoustic blanket comprises a main body, a margin and a fold line connecting the main body to the margin. The main body may be T-shaped. In one possible embodiment the margin has a width of between about 5 and 7 cm and more typically a width of about 6.3 cm. The acoustic blanket may be constructed from a number of materials including, for example, thermoplastic material. In one possible embodiment of the invention the main body and the margin are integrally formed from a material selected from a group consisting of polyester, polyolefin, polyethylene, rayon, nylon, acrylic, hemp, kenaf, cotton, fiberglass and combinations thereof. Further the fold line may be scored or perforated.

In accordance with yet another aspect of the present invention a dishwasher is provided. The dishwasher comprises a housing including a washing chamber and a door for gaining access to the washing chamber as well as a washing nozzle in the washing chamber for directing a fluid stream against dishes held in the washing chamber. The dishwasher further includes a circulation pump for circulating fluid under pressure through the washing nozzle. Still further the dishwasher includes an acoustical insulation blanket extending around the washing chamber. The acoustical insulation blanket includes a main body, a margin and a fold line connecting the main body to the margin. The margin is folded relative to the main body about the fold line to form an edge seal around an edge of the housing. In one possible embodiment the margin has a width of between about 5 and about 7 cm and more typically a width of about 6.3 cm.

The acoustic insulation blanket may be constructed from thermoplastic material. In one possible embodiment the main body and margin are integrally formed from a material selected from a group consisting of polyester, polyolefin, polyethylene, rayon, nylon, acrylic, hemp, kenaf, cotton, fiberglass and combinations thereof. The fold line may be scored or perforated.

In accordance with yet another aspect of the present invention a method is provided of forming an edge seal around an edge of an appliance housing with an acoustical blanket. The method comprises the steps of providing an acoustic blanket with a main body and a margin connected together by a fold line and folding the acoustic blanket about the fold line so as to extend the acoustic blanket around the edge of the housing and form an integral edge seal. The method further includes the step of securing the margin around the edge. This may be done by a procedure selected from a group consisting of impulse heat sealing, sonic welding, mechanical fastening and combinations thereof.

Still other objects of the present invention will become readily apparent to those skilled in this art from the following description wherein there is shown and described several embodiments of this invention simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain certain principles of the invention. In the drawings:

FIG. 1 is a top plan view of an acoustical blanket constructed in accordance with the teachings of the present invention;

FIG. 2 is a schematic view and partially cutaway perspective of a dishwasher incorporating an acoustic blanket forming a front edge seal; and

FIG. 3 is a schematical view illustrating how the margin of the acoustic blanket is folded about the fold line in order to provide an edge seal over the front edge of an appliance housing.

Reference will now be made in detail to the present preferred embodiment of the invention, an example of which is illustrated in the accompanying drawings.

### DETAILED DESCRIPTION AND PREFERRED EMBODIMENTS OF THE INVENTION

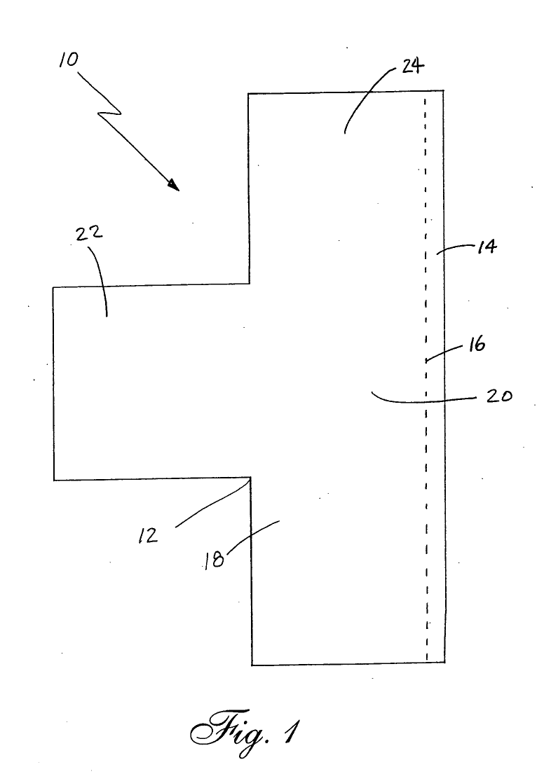

Reference is now made to FIG. 1 showing the acoustic blanket 10 of the present invention. As illustrated the acoustic blanket 10 includes a main body 12, a margin 14 and a fold line 16 connecting the main body to the margin.

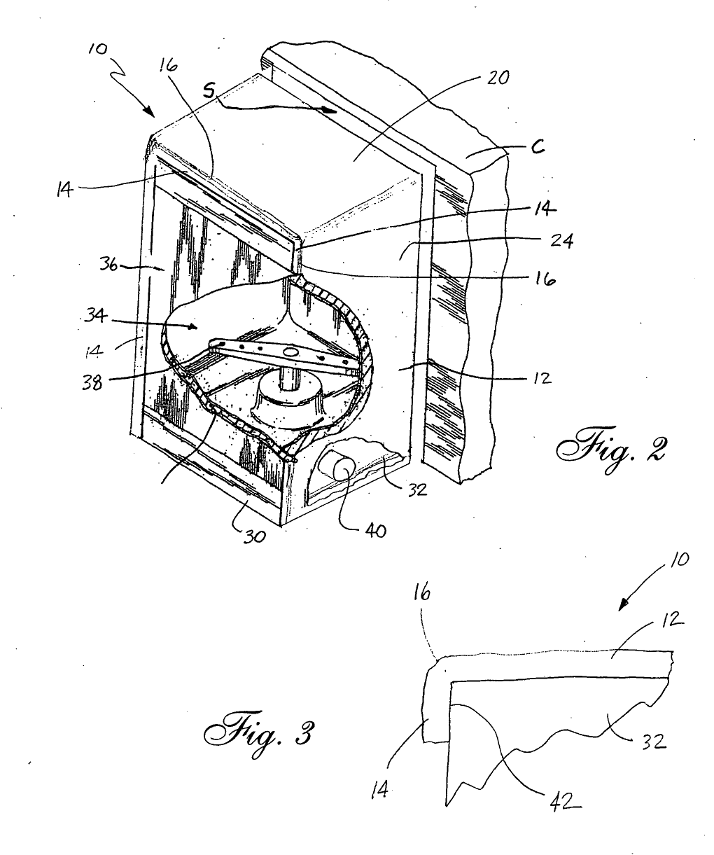

In the illustrated embodiment, the main body 12 is substantially T-shaped. As a consequence, the main body 12 includes a first section 18, a second section 20, a third section 22 and a fourth section 24. As illustrated in FIG. 2, when the acoustic blanket 10 is installed on a dishwasher 30, the first section 18 covers the right side of the dishwasher while the second, third and fourth sections 20, 22, 24 cover, respectively, the top, rear and left side of the dishwasher. The margin 14 is provided along the first, second and fourth sections 18, 20, 24 so that it may be folded along the fold line in a manner described in greater detail below to provide a seal for the front edge of the dishwasher 30.

The acoustic blanket 10 may be constructed from a thermoplastic material. In one possible embodiment both the main body 12 and margin 14 are integrally formed from a material selected from a group consisting of polyester, polyolefin, polyethylene, rayon, nylon, acrylic, hemp, kenaf, cotton, fiberglass and combinations thereof. Further the fold line 16 may be scored or perforated as desired. Typically the fold line 16 is positioned so as to provide a margin 14 having a width of between about 5 and about 7 cm and more typically a width of about 6.3 cm.

Reference is now made to FIG. 2 illustrating how the acoustic blanket 10 is utilized to insulate a kitchen appliance such as a dishwasher 30 adapted for mounting in a space S under a counter C. As illustrated the dishwasher 30 includes a housing 32 including both a washing chamber 34 and a door 36 for gaining access to the washing chamber. A washing nozzle 38 in the washing chamber 34 directs a fluid stream against dishes held in the washing chamber. A circulation pump 40 circulates that fluid under pressure through the washing nozzle 38.

As previously noted, the acoustical insulation blanket 10 extends around the washing chamber 24. As best illustrated in detail in FIG. 3, the margin 14 of the acoustical blanket 10 is folded about the fold line 16 relative to the main body 12 so as to form an edge seal around an edge 42 of the housing 32. The margin 14 is secured around the edge 42 by any appropriate means known in the art including, for example, impulse heat sealing, sonic welding, mechanical fastening and combinations thereof. The margin 14 may be slit and/or cut at the corners of the dishwasher 30 in order to allow the margin to be folded flat against the edge at those points.

The foregoing description of the preferred embodiments of the invention have been presented for purposes of illustration and description. It is not intended to be exhaustive or to limit the invention to the precise form disclosed. Obvious modifications or variations are possible in light of the above teachings. For example, while the illustrated embodiment includes a fold line 16 and margin 14 on the first, second and fourth sections 18, 20 and 24 of the main body 14, it should be appreciated that such a fold line and margin could simply be provided on only one, any two, any three or all four of the sections 18, 20, 22, 24.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiment do not and are not intended to limit the ordinary meaning of the claims and their fair and broad interpretation in any way.

What is claimed is:

1. An acoustic blanket for an appliance, comprising:
a main body;
a margin; and
a fold line connecting said main body to said margin.

2. The acoustic blanket of claim 1, wherein said margin has a width of between about 5 and about 7 cm.

3. The acoustic blanket of claim 1, wherein said margin has a width of about 6.3 cm.

4. The acoustic blanket of claim 1, wherein said acoustic blanket is constructed from thermoplastic material.

5. The acoustic blanket of claim 1, wherein said main body and margin are integrally formed from a material selected from a group consisting of polyester, polyolefin, polyethylene, rayon, nylon, acrylic, hemp, kenaf, cotton, fiberglass and combinations thereof.

6. The acoustic blanket of claim 1, wherein said fold line is scored.

7. The acoustic blanket of claim 1, wherein said fold line is perforated.

8. The acoustic blanket of claim 1, wherein said main body is substantially T-shaped.

9. A dishwasher, comprising:
a housing including a washing chamber and a door for gaining access to said washing chamber;
a washing nozzle in said washing chamber for directing a fluid stream against dishes held in said washing chamber;
a circulation pump for circulating fluid under pressure through said washing nozzle; and
an acoustical insulation blanket extending around said washing chamber said acoustical insulation blanket including a main body, a margin and a fold line connecting said main body to said margin.

10. The dishwasher of claim 9, wherein said margin is folded relative to said main body about said fold line to form an edge seal around an edge of said housing.

11. The dishwasher of claim 10, wherein said margin has a width of between about 5 and about 7 cm.

12. The dishwasher of claim 10, wherein said margin has a width of about 6.3 cm.

13. The dishwasher of claim 9, wherein said acoustic insulation blanket is constructed from thermoplastic material.

14. The dishwasher of claim 9, wherein said main body and margin are integrally formed from a material selected from a group consisting of polyester, polyolefin, polyethylene, rayon, nylon, acrylic, hemp, kenaf, cotton, fiberglass and combinations thereof.

15. The dishwasher of claim 9, wherein said fold line is scored.

16. The dishwasher of claim 9, wherein said fold line is perforated.

17. A method of forming an edge seal around an edge of an appliance housing with an acoustic blanket, comprising:
providing an acoustic blanket with a main body and a margin connected together by a fold line; and
folding said acoustic blanket about said fold line so as to extend said acoustic blanket around said edge of said housing and form an integral edge seal.

18. The method of claim 17 including securing said margin around said edge by a procedure selected from a group consisting of impulse heat sealing, sonic welding, mechanical fastening and combinations thereof.
